(19) United States
(12) Patent Application Publication
(10) Pub. No.: US 2015/0117562 A1
(43) Pub. Date: Apr. 30, 2015

(54) Coordinated Multi-Point Transmission and Reception (CoMP) with Non-Ideal Backhaul (NIB)

(71) Applicant: NEC Laboratories America, Inc., Princeton, NJ (US)

(72) Inventors: Narayan Prasad, I, Wyncote`, PA (US); Mohammad Khojastepour, Lawrenceville, NJ (US); Mustafa Arslan, Princeton, NJ (US); Karthikeyan Sundaresan, Howell, NJ (US); Sampath Rangarajan, Bridgewater, NJ (US)

(21) Appl. No.: 14/527,800

(22) Filed: Oct. 30, 2014

Related U.S. Application Data
(60) Provisional application No. 61/898,132, filed on Oct. 31, 2013.
(60) Provisional application No. 61/933,785, filed on Jan. 30, 2014.

(51) Int. Cl. H04B 7/06; H04B 7/02

(52) U.S. Cl. CPC H04B 7/0626; H04B 7/024
USPC 375/267

(57) ABSTRACT

A wireless communications method implemented in a transmission point (TP) used in a mobile communications system is disclosed. The wireless communications method includes receiving, from another TP, short-term channel state information (short-term CSI), and processing the short-term CSI. Other methods, systems, and apparatuses also are disclosed.

This application claims the benefit of U.S. Provisional Application No. 61/898,132, entitled “Scheduling and Signaling Issues in CoMP-NIB,” filed on Oct. 31, 2013, and U.S. Provisional Application No. 61/933,785, entitled “Signaling Considerations for CoMP with Non-Ideal Backhaul,” filed on Jan. 30, 2014, the contents of both of which are incorporated herein by reference.

### BACKGROUND OF THE INVENTION

1 Introduction

The present invention relates to coordinated multi-point transmission and reception (CoMP) in wireless or mobile communications and, more particularly, to CoMP with non-ideal backhaul (NIB).

During 3GPP (The 3rd Generation Partnership Project) TSG (Technical Specification Group) RAN (Radio Access Network) Meeting #60, the study of CoMP with a non-ideal backhaul (CoMP-NIB) was approved to consider the following objectives [1]:
RAN1 (RAN Working Group 1 or Radio Layer 1) evaluates coordinated scheduling and coordinated beamforming including semi-static point selection/muting as candidate techniques for CoMP involving multiple eNBs with non-ideal but typical backhaul and, if there is performance benefit, recommend for which CoMP technique(s) signalling for inter-eNB (E-UTRAN NodeB or eNodeB) operation should be specified, considering potential impact on RAN3 work.

1) In the evaluations, consider the level of backhaul delay achievable with non-ideal backhaul.

2) Evaluation should be on the CoMP operation between macro eNBs (CoMP scenario 2 except for the backhaul assumptions), between macro eNB and small cell eNB (small cell scenario #1 with non-ideal backhaul), and between small cell eNBs (small cell scenario #2a with non-ideal backhaul).

3) The study will take into account the outcome of the small cell enhancement study item and previous work on 3GPP Release 11 CoMP SI (study item)/WI (working item).

We describe a scheduling scheme which is suitable for CoMP-NIB. This scheme considers joint optimization of a system utility via semi-static point switching (SSPS) and semi-static coordinated beamforming (SSCB) (which includes semi-static point muting (SSPM) as a special case).

Transmission layers are sometimes called “transmit layers” or “layers.” The number of transmission layers is known as “transmission rank” or “rank.” A codebook is a set of precoding matrices or precoders. A precoding matrix is also known as a codeword.

### REFERENCE

[1] 3GPP RP-130847, “Study on CoMP for LTE with non-ideal backhaul.”

### BRIEF SUMMARY OF THE INVENTION

An objective of the present invention is to provide a suitable scheme for CoMP operation with a non-ideal backhaul network.

An aspect of the present invention includes a wireless communications method implemented in a transmission point (TP) used in a mobile communications system. The wireless communications method comprises receiving, from another TP, short-term channel state information (short-term CSI), and processing the short-term CSI.

Another aspect of the present invention includes a transmission point (TP) used in a mobile communications system. The transmission point (TP) comprises a receiver to receive, from another TP, short-term channel state information (short-term CSI), wherein the TP processes the short-term CSI.

Still another aspect of the present invention includes a wireless communications method implemented in mobile communications system. The wireless communications method comprises transmitting, to a transmission point (TP) from another TP, short-term channel state information (short-term CSI), and processing the short-term CSI.

Still another aspect of the present invention includes a mobile communications system. The mobile communications system comprises a user equipment (UE), and a transmission point (TP) to receive, from another TP, short-term channel state information (short-term CSI), wherein the TP processes the short-term CSI, and wherein the short-term CSI is transmitted from the user equipment (UE) to said another TP.

An aspect of the present invention includes a wireless communications method implemented in a transmission point (TP) used in a mobile communications system. The wireless communications method comprises receiving, from a user equipment (UE), short-term channel state information (short-term CSI), processing the short-term CSI, and transmitting, to another TP, the processed short-term CSI.

Another aspect of the present invention includes A transmission point (TP) used in a mobile communications system. The transmission point (TP) comprises a receiver to receive from a user equipment (UE), short-term channel state information (short-term CSI), and a transmitter to transmit, to another TP, the processed short-term CSI, wherein the TP processes the short-term CSI.

Still another aspect of the present invention includes a wireless communications method implemented in mobile communications system. The wireless communications method comprises transmitting, from a user equipment (UE) to a transmission point (TP), short-term channel state information (short-term CSI), processing the short-term CSI, and transmitting, from the TP to another TP, the processed short-term CSI.

Still another aspect of the present invention includes a mobile communications system. The mobile communications system comprises a user equipment (UE), and a transmission point (TP) to receive, from the user equipment (UE), short-term channel state information (short-term CSI), wherein the TP processes the short-term CSI, and transmits, to another TP, the processed short-term CSI.

### BRIEF DESCRIPTION OF THE DRAWINGS

FIG. 1 depicts an assignment (bi-partite matching) problem, which is equivalent to the optimization problem in (P2) below.

FIG. 2 depicts a greedy SSPS algorithm.

FIG. 3 depicts an algorithm to sub-optimally solve the joint SSCB and SSPS problem in (P1) below.

FIG. 4 depicts a block diagram of a CoMP system.

### DETAILED DESCRIPTION

2A Scheduling Scheme for CoMP with Non-Ideal Backhaul

The CoMP schemes that were discussed during the 3GPP Release 11 CoMP standardization assumed the availability of an ideal backhaul connecting the transmission points in each cluster. This assumption allowed for coordination within the cluster based on the instantaneous CSI (channel state information) reported by the users to those transmission points. Unfortunately, such schemes are far from being suitable when faced with a non-ideal backhaul that has a high latency. To guide the design of schemes that are appropriate for the NIB scenario, the following agreement was reached during the RAN1#74 meeting:

For each evaluated scheme, information relating to a transmission to/from a serving node in a given subframe should be categorized into two groups:
Group 1 information: information which is considered valid for a period longer than the backhaul delay, which may therefore be provided from a different node(s) from the serving node;
Group 2 information: information which is considered valid for a period shorter than the backhaul delay, which may therefore be derived by the serving node.

The types of information may include for example:
CSI (channel state information)
Allocated power per resource (including muting)
UE (user equipment) selection
Precoding selection (including the number of transmit layers)
MCS (modulation and coding scheme) selection
HARQ (Hybrid Automatic Repeat Request) process number
TP (transmission point) selection

We first propose a mathematical framework for designing a scheduling scheme for CoMP-NIB consistent with the above agreement. We then obtain a scheduling scheme using this framework, and then propose the signaling support that can be used to realize that scheme.

2.1A Optimizing Proportional Fairness Utility Metric

Suppose that there are K users and B transmission points (TPs) in the coordination area or zone of interest. For convenience in exposition, we assume a full buffer traffic model and let Ω denote the set of K users. We consider schemes where the assignment of precoding matrices (beamforming vectors) to the B TPs and the association of users with those TPs (i.e., point switching) are done in a semi-static manner based on average estimates of SINRs, rates etc. On the other hand, given its assigned precoder (or beam) and the users associated with it, each TP does per sub-frame scheduling independently based on the instantaneous CSI.

Let Ŵ=(W₁, . . . , W_{B}) denote an assignment of a precoder tuple, where Wᵢ is the precoder assigned to the i^{th} TP. Here each precoder Wᵢ can be chosen from a pre-determined finite set Ψ which includes a codeword 0 and Wᵢ=0 means that the i^{th TP is muted. Thus, SSPM is subsumed as a special case.}

Then, let Rᵤ^{b}(Ŵ) denote an estimate of the average rate that user u can obtain when it is served data by TP b, given that the precoder tuple Ŵ is assigned to the B TPs and that no other user is associated with TP b. Next, suppose that m total users are associated with TP b. Following the conventional approach the average rate that user u can obtain under proportional fair per-subframe scheduling can be approximated as

$$\frac{{R}_{u}^{b} ( \hat{W} )}{m} .$$

With these definitions in hand, we can jointly determine the assignment of a precoding tuple and the user association (e.g., jointly consider SSCB and SSPS problems) by solving the following optimization problem:

$${max}_{\hat{W} , \{ {x}_{u , b} \}} \{ {\sum }_{u , b}^{ } {x}_{u , b} log ( \frac{{R}_{u}^{b} ( \hat{W} )}{{\sum }_{k}^{ } {x}_{k , b}} ) \} \\ s . t . {\sum }_{b}^{ } {x}_{u , b} = 1 , ∀ u ; {x}_{u , b} ∈ \{ 0 , 1 \} , ∀ u , b \\ \hat{W} = ( {W}_{1} , … , {W}_{B} ) , {W}_{i} ∈ Ψ , ∀ i \qquad ( P1 )$$

Note that in (P1), each x_{u,b} is an indicator variable which is equal to one if user u is associated with TP b and zero otherwise. Therefore the constraint in (P1) enforces that each user is associated with only one TP. We offer the following result on the problem in (P1).

Observation-1: The Joint Optimization Problem in (P1) is Strongly NP-Hard.

The implication of Observation-1 is that (P1) cannot be solved optimally in an efficient manner, which necessitates the design of low-complexity algorithms that can approximately solve (P1).

Towards this end, we consider the user association or equivalently the SSPS sub-problem, for any given precoder tuple Ŵ, which can be written as:

$${max}_{\{ {x}_{u , b} \}} \{ {\sum }_{u , b}^{ } {x}_{u , b} log ( \frac{{R}_{u}^{b} ( \hat{W} )}{{\sum }_{k}^{ } {x}_{k , b}} ) \} \\ s . t . {\sum }_{b}^{ } {x}_{u , b} = 1 , ∀ u ; {x}_{u , b} ∈ \{ 0 , 1 \} , ∀ u , b \qquad ( P2 )$$

Fortunately, as stated in the following result the SSPS problem (P2) can indeed be optimally solved.

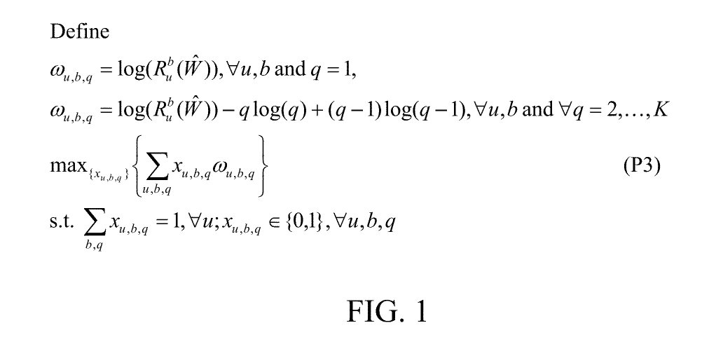

Observation-2: The Optimization Problem in (P2) is Equivalent to the Assignment (Bipartite Matching) Problem in (P3) Given in the FIG. 1.

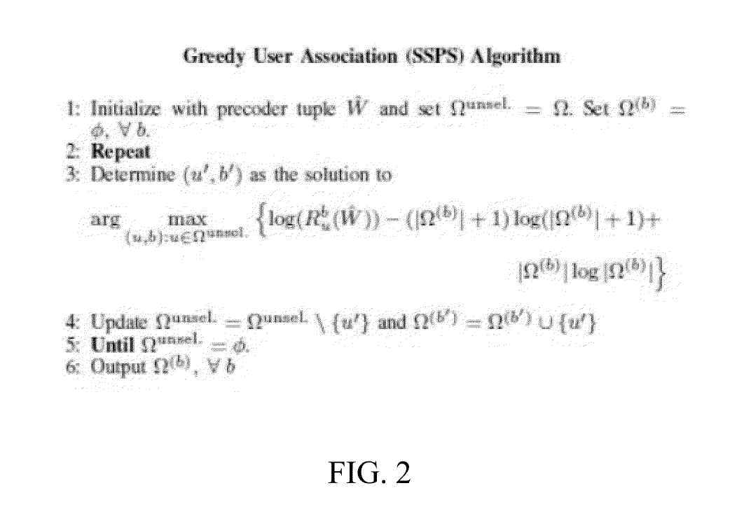

The implication of Observation-2 is that (P2) can be optimally solved using the Auction algorithm or the Hungarian algorithm on the re-formulation in (P3). Alternatively, a greedy approach can be adopted to achieve further complexity reduction. The latter greedy SSPS algorithm is given in FIG. 2, where we use φ to denote the empty set, Ω^{unsel.} to denote the remaining unselected users who have not yet been associated with any TP and Ω^{(b)} to denote the set of users associated with TP b. We also have adopted that convention that 0 log(0)=0.

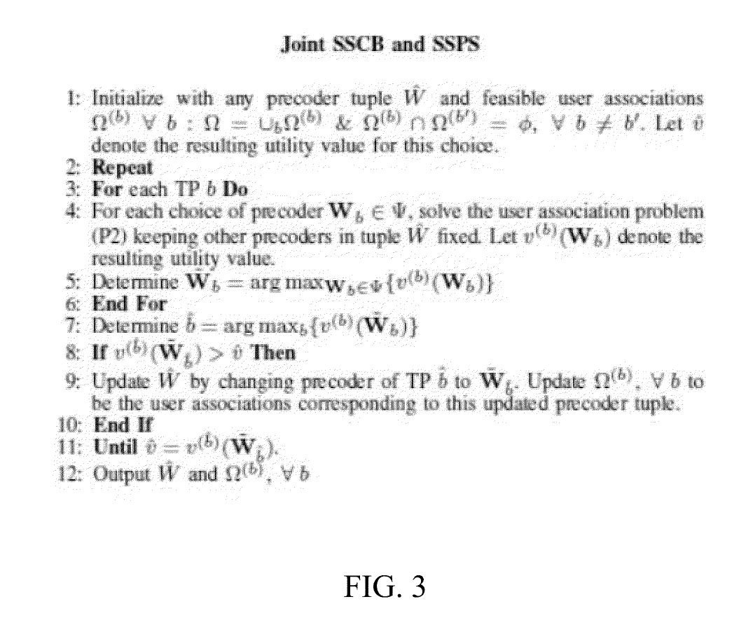

These solutions to the SSPS problem can be leveraged to obtain an algorithm to sub-optimally solve the joint SSCB and SSPS problem (P1). One such algorithm is depicted in FIG. 3.

Note that the user association sub-problems that arise in the joint algorithm of FIG. 3 can either be solved optimally (using the Hungarian or Auction algorithm on (P3)) or can be solved sub-optimally using the greedy algorithm given in FIG. 2.

2.2A Extensions and Variations

One simple extension is to implement the aforementioned algorithms independently on each sub-band. A more nuanced one is one where the precoder tuple assignment can be optimized independently on each sub-band but the user association can only be optimized on a wideband basis, i.e., the user association is subject to an additional constraint that each user is associated with only one TP on all the sub-bands.

Another variation motivated by some practical concerns is as follows. In certain network architectures it might be difficult to freely move user data among all TPs. In addition, since a user is configured to report short-term CSI only to its anchor TP, restrictions on how frequently the choice of anchor TP can be altered for a given user can often limit the flexibility of point switching for that user. This is because per-subframe scheduling is performed independently by each TP over the users associated to it, based on the short-term CSI. Under a high backhaul latency such short-term CSI might be meaningful for per-subframe scheduling only if it is directly received by that TP from the users associated to it.

To address such scenarios we note that in our formulation we can readily accommodate restrictions on point switching for any user. In particular, to disallow the possibility of a user u switching to TP b, we can simply set Rᵤ^{b}(Ŵ)=0 (or some small enough value) for all possible choices of the precoder tuple assignment Ŵ.

3A Signaling Support

The proposed SSPS and joint SSCB and SSPS algorithms can be implemented in a centralized manner at a designated master transmission point (MTP) in the coordination zone of interest. To enable implementation two types of backhaul signaling are desirable. We assume that for each user a measurement set containing up-to three TPs among those in the coordination zone is defined and held fixed for a time scale even coarser than the one at which the precoder tuple assignment and user association is done. This measurement set includes the anchor TP for that user, e.g., the TP from which that user sees the strongest average received signal strength among all TPs. It also includes up-to two other TPs in the zone from whom that user sees an average received signal strength greater than a (configurable) fraction times that seen from its anchor.

3.1A Backhaul Signaling to Enable Determination of Precoder Tuple Assignments and the User Associations

All TPs in the coordination zone report enough information over the (non-ideal) backhaul to the MTP to allow it to determine the precoder tuple assignments and the user associations.

Notice that the key entity in the implementation of the proposed algorithms is an estimate of Rᵤ^{b}(Ŵ) or each user u, each TP b in its measurement set and for all precoder tuple assignments. For any precoder tuple Rᵤ^{b}(Ŵ) is taken to be non-negligible only if the TP b is in the measurement set of user u. Notice also that Rᵤ^{b}(Ŵ) can be assumed to be equal to Rᵤ^{b}(Ŵ′) for any two precoder tuple assignments Ŵ and Ŵ′ which differ only in precoders assigned to TPs not in the measurement set of user u.

We will now consider computation of these average rate estimates at the MTP for some user u, under a precoder tuple assignment Ŵ. These rates depend on the channels that the UE (i.e., user u) sees from TPs in its measurement set. Using up-to three CSI processes (recall that the maximum measurement set size is three) which include a common IMR (interference measurement resource), the UE can be configured to report short-term CSI for each TP b in its measurement set, where this short-term CSI is computed based on the non-zero CSI reference symbols (CSI-RS) transmitted by TP b and the interference observed on the IMR, which in turn includes only the interference from TPs not in the measurement set of user u. This short-term CSI can consist of any one of the following options: (i) a wideband PMI (precoding matrix indicator) and subband CQI(s) (channel quality indicator(s)), (ii) a wideband PMI (which can possibly indicate the identity matrix) and sub-band PMI along with subband CQI(s). In case (ii) the wideband PMI can be selected by the UE from a wideband codebook and can be reported at a slower rate than the sub-band PMIs and subband CQI(s).

These short-term CSI are typically reported by each UE to its anchor TP from where they can be sent to the MTP over the backhaul, which then filters the received CSI sequence to obtain an averaged channel estimate Hᵤ^{b} for each TP b in the measurement set of user u. These averaged channel estimates for all TPs in that UE's measurement set can be used to compute Rᵤ^{b}(Ŵ) for each precoder tuple hypothesis Ŵ and each TP b in its measurement set, under the assumption that the signal transmitted by each TP (along its assigned precoder under that hypothesis) is isotropically distributed.

Alternatively, the MTP can filter the received CSI sequence to obtain an averaged covariance estimate (Hᵤ^{b})*Hᵤ^{b} for each TP b in the measurement set of user u. These averaged covariance estimates for all TPs in that UE's measurement set can be used to compute all Rᵤ^{b}(Ŵ).

In another option, the filtering can be done instead by the anchor TP of each user (to which that user reports its short-term CSI). The anchor TP can periodically send the filtered channel (or covariance) estimates for each user (for whom it is the anchor) over the backhaul to the MTP. In one embodiment, a TP might just send the wideband PMI in option (ii) above along with the corresponding averaged CQIs to the MTP.

Another approach is described next. Here, the MTP first determines a set of candidate precoder tuples {Ŵ} and then determines estimates of average rates {Rᵤ^{b}(Ŵ)} for each user u and TP b (in its measurement set) directly from the user's CSI reports. In particular, the MTP sequentially considers each precoder tuple Ŵ in the candidate set, and configures CSI processes for all users (and possibly window sizes for measuring/averaging the interference over the constituent IMRs) such that the resulting CSI determined by each user (using the CSI processes configured for it) corresponds to the scenario in which each TP transmits using its assigned precoder in the tuple Ŵ. Note that here the non-zero power CSI-RS transmitted by each TP can be precoded by its respective assigned precoder, where the assigned precoder (under the candidate tuple) is conveyed over the backhaul from the MTP to the TP. Moreover each TP is also conveyed the CSI process configurations of all users for whom it is the anchor. The short term CSI feedback by each user can be filtered (for example the CQIs can be averaged) to determine the average rate estimates for that user. This filtering can be done at the anchor which can then send the rate estimates to the MTP over the backhaul.

Furthermore, the choice of the set of candidate precoder tuples can itself be determined in a preceding setup phase. This phase could operate like the ones described before and the candidate tuples can be determined based on the filtered channel or covariance estimates. The sequence in which the tuples in the candidate set are considered is determined by the MTP.

Notice that the approach described above is particularly simplified (in terms of configuring CSI processes) if the user associations are fixed, i.e., under a restriction that each user can only be served data by its anchor TP.

Some comments on the set Ψ which contains the set of precoders that can be assigned to each TP, are on order.

We recall that this set includes 0 to subsume muting as a special case. It can also include codewords of the form αI where α denotes a positive power level. In addition, it can include sector beams as its codewords and can itself be configured by the MTP in a semi-static manner.

3.2A Backhaul Signaling from MTP to TPs

Each TP is informed (semi-statically) about the precoder it uses and the users it serves. Each TP then implements its own per-subframe scheduling based on the instantaneous C SI.

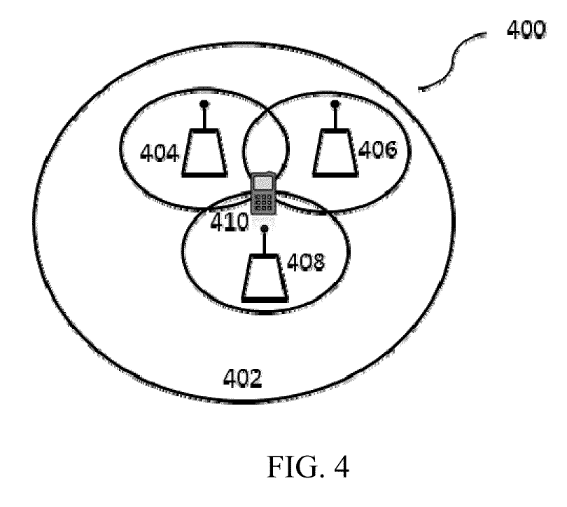

Referring now to FIG. 4, a CoMP mobile communications system 400 comprising a CoMP coordination zone or area or CoMP cooperating set 402 in which the embodiments may be implemented is illustrated. One or more user equipments 410 are served by one or more TPs or cells 404 to 408. TPs 404 to 408 can be base stations or eNBs. Each of the user equipments includes e.g. a transmitter and a receiver, and each of the base stations or eNBs 104 includes e.g. a transmitter and a receiver.

4A Conclusion

We propose a scheduling scheme that is suitable for CoMP-NIB. This scheme jointly considers both SSCB (including SSPM as a special case) and SSPS, and is obtained by optimizing the proportional fairness utility. Signaling support which is preferable to enable such a scheme was also proposed.

2B Scheduling Scheme for CoMP with Non-Ideal Backhaul

In Sections 2A to 4A, we proposed a mathematical framework for designing a scheduling scheme for CoMP-NIB consistent with the agreement in section 2A. That framework allows for the construction of hybrid scheduling schemes where certain actions (such as the assignment of a precoder for each TP in the coordination unit or zone and the set of users associated to each TP in that zone) are made at a centralized node at a coarse time-scale, while the remaining ones that rely on fast changing information (such as the per subframe user scheduling at each TP) are independently made by each TP at a fine time scale.

We recapitulate the framework in the appendix and proceed to discuss the signaling support needed to realize such hybrid scheduling schemes.

3B Signaling Support

We assume that for each user a measurement set containing up-to three TPs among those in the coordination zone is defined and held fixed for a time scale even coarser than the one at which the centralized decisions (precoder tuple or muting pattern assignment and user association) are made.

From the description given in the appendix, we see that to determine the centralized decisions (such as the precoder tuple assignment and the user associations) under the full buffer traffic model, the master TP (MTP) may be able to obtain, Rᵤ^{b}(Ŵ), which we recall denotes an estimate of the average rate that user u can obtain (over the available time-frequency resource normalized to have size unity) when it is served data by TP b, given that the precoder tuple W is assigned to the TPs in the zone and that no other user is associated with TP b. Recall also that the precoder tuple W can also correspond to a muting pattern deciding which TPs should be active and which should be turned off in the time-frequency unit. This average estimate Rᵤ^{b}(Ŵ) must be obtained for each user u, each TP b in its measurement set and for all precoder tuple assignments. Note that for any precoder tuple, Rᵤ^{b}(Ŵ) can be considered to be negligible if the TP b is not in the measurement set of user u. Notice also that Rᵤ^{b}(Ŵ) can be assumed to be equal to Rᵤ^{b}(Ŵ) for any two precoder tuple assignments Ŵ and Ŵ′ which differ only in precoders assigned to TPs not in the measurement set of user u. Under the finite buffer model, the MTP also needs (estimates) of buffer sizes to make the centralized decisions. Thus, the following types of backhaul signaling are needed.

3.1B Backhaul Signaling to Enable Determination of Centralized Actions (Such as Precoder Tuple/Muting Pattern Assignments and the User Associations)

We will now consider computation of the average rate estimates {Rᵤ^{b}(Ŵ)} at the MTP for some user u, under a precoder tuple assignment Ŵ. These rates depend on the channels that the user sees from TPs in its measurement set. Using up-to three CSI processes (recall that the maximum measurement set size is three) which include a common IMR, the UE can report short-term CSI for each TP b in its measurement set, where this short-term CSI is computed based on the non-zero CSI-RS transmitted by TP b and the interference observed on the IMR, which in turn includes only the interference from TPs not in the measurement set of user u. The UE currently reports such CSI only to its designated anchor TP.

However, to fully exploit point switching gains we need to allow for the possibility of associating a user to a non-anchor TP and then allowing that user to report instantaneous (short-term) CSI to the non-anchor TP it has been associated to. Further, the CSI processes can be defined in a coordinated manner so that the users measure the appropriate interference on the constituent IMRs. Such coordinated configuration of IMRs also provides the ability to inject the desired interference (such as isotropically distributed interference) onto resource elements in those IMRs.

These short-term CSI can be sent to the MTP over the backhaul, which can then filter (e.g. perform a weighted average of) the received CSI sequence to obtain an averaged channel estimate Hᵤ^{b} for each TP b in the measurement set of user u. Alternatively, the averaging can be done by the TP receiving the short-term CSI but where the averaging window (and possibly the weighting factors) can be configured for that UE on a per CSI-process basis. Note that a default value for these averaging parameters could be set to correspond to no averaging.

In either case, these averaged channel estimates for all TPs in that UE's measurement set can be used by the MTP to compute Rᵤ^{b}(Ŵ) for each precoder tuple hypothesis Ŵ and each TP b in its measurement set, under the assumption that the signal transmitted by each TP (along its assigned precoder under that hypothesis) is isotropically distributed.

These views are summarized in the following proposals:

Proposal: Signaling of averaged CSI obtained over each CSI process by a TP to a designated master TP over the backhaul should be supported. The averaging parameters such as window size and weights should be configurable. Coordination in configuring these CSI processes should be allowed.

Proposal: Possibility of configuring a user to report short-term CSI to more than one TP or a chosen TP in a configurable set of TPs should be considered.

Next, recall that in the more general finite buffer model estimates of the queue sizes are needed to determine each coarse (centralized) action, where each such user queue size represents the amount of traffic that would available for transmission to serve that user until the next coarse action. Determining estimates of these queue sizes requires the TPs to report their most-recently updated associated user queue sizes before the next coarse action to the MTP.

Finally, the methods described in the appendix seek to optimize the proportional fairness utility (over all possible choices for the centralized action) in a memory-less fashion. However, if our objective is to optimize the utility over a long-time horizon then the MTP would require the estimates of the most-recently updated user PF weights before each coarse action.

Proposal: Signaling of associated user queue sizes and PF weights by each TP to the master TP should be considered.

3.2B Backhaul Signaling from MTP to TPs

Each TP is informed (semi-statically) about the precoder it should use and the users it should serve. Each TP then implements its own per-subframe scheduling based on the instantaneous CSI it receives from the users associated to it. Some comments on the set Ψ which contains the set of precoders that can be assigned to each TP, are on order. We recall that this set includes codeword 0 to subsume muting as a special case. It can also include codewords of the form αI where α denotes a positive power level. In addition, it can include sector beams as its codewords.

Proposal: Signaling of decisions made by the master TP (such as precoder set or muting pattern assignment, user associations) to all other TPs over the backhaul should be supported.

4B Conclusion

We provided our views on backhaul signaling needed for CoMP-NIB comprising of the following proposals:

Proposal: Signaling of average CSI obtained over each CSI process by a TP to a designated master TP over the backhaul should be supported. The averaging parameters such as window size and weights should be configurable. Coordination in configuring these CSI processes should be allowed.

Proposal: Possibility of configuring a user to report short-term CSI to more than one TP or a chosen TP in a configurable set of TPs should be considered.

Proposal: Signaling of associated user queue sizes and PF weights by each TP to the master TP should be considered.

Proposal: Signaling of decisions made by the master TP (such as precoder set or muting pattern assignment, user associations) to the other TPs over the backhaul should be supported.

### APPENDIX

Optimizing Proportional Fairness Utility Metric

Suppose that there are K users and B transmission points (TPs) in the coordination area or zone of interest. For convenience in exposition, we first assume a full buffer traffic model and let Ω denote the set of K users. We consider hybrid schemes where the assignment of precoding matrices (beamforming vectors) to the B TPs and the association of users with those TPs (i.e., point switching) are done in a semi-static centralized manner based on average estimates of SINRs, rates etc. On the other hand, given its assigned precoder (or beam) and the users associated with it, each TP does per sub-frame scheduling independently based on the instantaneous CSI.

Let Ŵ=(W₁, . . . , W_{B}) denote an assignment of a precoder tuple, where W_{b} is the precoder assigned to the b^{th} TP. Here each precoder W_{b} can be chosen from a pre-determined finite set W which includes a codeword 0 and W_{b}=0 means that the b^{th} TP is muted. Thus, SSPM is subsumed as a special case.

Then, let Rᵤ^{b}(Ŵ) denote an estimate of the average rate that user u can obtain (over the available time-frequency resource normalized to have size unity) when it is served data by TP b, given that the precoder tuple Ŵ is assigned to the B TPs and that no other user is associated with TP b. This time-frequency unit could for example be a set of resource blocks. Next, suppose that m total users are associated with TP b. Following the conventional approach, the average rate that user u can then obtain under proportional fair per-subframe scheduling can be approximated as

$$\frac{{R}_{u}^{b} ( \hat{W} )}{m} .$$

With these definitions in hand, we can jointly determine the assignment of a precoding tuple and the user association (e.g., jointly consider semi-static coordinated beamforming (SSCB) and semi-static coordinated point-switching (SSPS) problems) by solving the optimization problem in (P1).

Note that in (P1), each x_{u,b} is an indicator variable which is equal to one if user u is associated with TP b and zero otherwise. Therefore the constraint in (P1) enforces that each user must be associated with only one TP. It can be shown that (P1) cannot be solved optimally in an efficient manner, which necessitates the design of low-complexity algorithms that can approximately solve (P1).

Towards this end, we consider the user association or equivalently the SSPS sub-problem, for any given precoder tuple Ŵ, which can be written as in (P2).

Fortunately, as stated in Sections 2A to 4A, the SSPS problem (P2) can indeed be optimally solved using the Auction algorithm or the Hungarian algorithm on an equivalent assignment problem. Alternatively, a greedy approach can be adopted to achieve further complexity reduction. The latter greedy SSPS algorithm is given in FIG. 2.

These solutions to the SSPS problem can be leveraged to obtain an algorithm to sub-optimally solve the joint SSCB and SSPS problem (P1). One such algorithm is depicted in FIG. 3.

For finite buffer model the problem (P1) can be modified as

$${max}_{\hat{W} , \{ {x}_{u , b} \}} \{ {\sum }_{u , b}^{ } {x}_{u , b} log ( {γ}_{u , b} {\hat{R}}_{u}^{b} ( \hat{W} ) ) \} \\ s . t . {\sum }_{b}^{ } {x}_{u , b} = 1 , ∀ u ; {x}_{u , b} ∈ \{ 0 , 1 \} , ∀ u , b \\ {\sum }_{u}^{ } {γ}_{u , b} \leq 1 , ∀ b ; {γ}_{u , b} ∈ [ 0 , 1 ] , {γ}_{u , b} {\hat{R}}_{u}^{b} ( \hat{W} ) \leq {Q}_{u} , ∀ u , b \\ \hat{W} = ( {W}_{1} , … , {W}_{B} ) , {W}_{b} ∈ Ψ , ∀ b \qquad ( {P1}^{′} )$$

where Qᵤ is the normalized queue size (or an estimated normalized queue size) of user u. Heuristics can then be developed to solve (P1′).

Extensions and Variations

One extension is to split the available time-frequency resource unit into a set of orthogonal time-frequency resource sub-units. For instance, such sub-units could all span a common time interval but have non-overlapping frequencies. Alternatively, such sub-units could all span a common bandwidth but have non-overlapping time intervals, or in general a combination of these two approaches is possible. Then, the precoder tuple assignment can be optimized separately on each sub-unit while the user association can only be optimized subject to an additional constraint that each user must be associated with only one TP across all the sub-units.

An illustrative formulation which extends the one in (P1′) to two sub-units is the following. We note that extensions to more than two sub-units can be done in an analogous manner.

$${max}_{{\hat{W}}^{1} , {\hat{W}}^{2} , \{ {γ}_{u , b}^{1} , {γ}_{u , b}^{2} , {x}_{u , b} \}} \{ {\sum }_{u , b}^{ } {x}_{u , b} log ( {γ}_{u , b}^{1} {a}_{1} {\hat{R}}_{u}^{b} ( {\hat{W}}^{1} ) + {γ}_{u , b}^{2} {a}_{2} {\hat{R}}_{u}^{b} ( {\hat{W}}^{2} ) ) \} \\ s . t . {\sum }_{b}^{ } {x}_{u , b} = 1 , ∀ u ; {x}_{u , b} ∈ \{ 0 , 1 \} , ∀ u , b \\ {\sum }_{u}^{ } {γ}_{u , b}^{1} \leq 1 , {\sum }_{u}^{ } {γ}_{u , b}^{2} \leq 1 ∀ b ; \\ {γ}_{u , b}^{1} , {γ}_{u , b}^{2} ∈ [ 0 , 1 ] , {γ}_{u , b}^{1} {a}_{1} {\hat{R}}_{u}^{b} ( {\hat{W}}^{1} ) + {γ}_{u , b}^{2} {a}_{2} {\hat{R}}_{u}^{b} ( {\hat{W}}^{2} ) \leq {Q}_{u} , ∀ u , b \\ {\hat{W}}^{i} = ( {W}_{1}^{i} , … , {W}_{B}^{i} ) , {W}_{b}^{i} ∈ {Ψ}^{i} , ∀ b ∀ i = 1 , 2 \qquad ( P4 )$$

We note that in (P4), a₁,a₂ε[0,1]: a₁+a₂=1 are fractions representing the relative sizes of the two sub-units within the available time-frequency resource of size unity. We also allow for the possibility of configuring different codebook or set of precoders for each sub-unit. A simplification of (P4) is the following:

$${max}_{{\hat{W}}^{1} , {\hat{W}}^{2} , \{ {γ}_{u , b} , {x}_{u , b} \}} \{ {\sum }_{u , b}^{ } {x}_{u , b} log ( {γ}_{u , b} ( {a}_{1} {\hat{R}}_{u}^{b} ( {\hat{W}}^{1} ) + {a}_{2} {\hat{R}}_{u}^{b} ( {\hat{W}}^{2} ) ) ) \} \\ s . t . {\sum }_{b}^{ } {x}_{u , b} = 1 , ∀ u ; {x}_{u , b} ∈ \{ 0 , 1 \} , ∀ u , b \\ {\sum }_{u}^{ } {γ}_{u , b} \leq 1 , ∀ b ; \\ {γ}_{u , b} , ∈ [ 0 , 1 ] , {γ}_{u , b} ( {a}_{1} {\hat{R}}_{u}^{b} ( {\hat{W}}^{1} ) + {a}_{2} {\hat{R}}_{u}^{b} ( {\hat{W}}^{2} ) ) \leq {Q}_{u} , ∀ u , b \\ {\hat{W}}^{i} = ( {W}_{1}^{i} , … , {W}_{B}^{i} ) , {W}_{b}^{i} ∈ {Ψ}^{i} , ∀ b ∀ i = 1 , 2 \qquad ( P5 )$$

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A wireless communications method implemented in a transmission point (TP) used in a mobile communications system, the wireless communications method comprising:
receiving, from another TP, short-term channel state information (short-term CSI); and
processing the short-term CSI.

2. The wireless communications method as in claim 1, wherein the TP comprises a master transmission point (MTP).

3. The wireless communications method as in claim 1, wherein the short-term CSI is received from said another TP over backhaul.

4. The wireless communications method as in claim 1, wherein and said another TP comprises an anchor TP.

5. The wireless communications method as in claim 1, wherein the processing comprises filtering the short-term CSI.

6. The wireless communications method as in claim 1, wherein the processing comprises performing an average of the short-term CSI.

7. The wireless communications method as in claim 6, wherein the average comprises a weighted average.

8. The wireless communications method as in claim 1, wherein the processed short-term CSI comprises an averaged channel estimate for each TP in a measurement set.

9. The wireless communications method as in claim 1, wherein the processed short-term CSI comprises an averaged covariance estimate for each TP in a measurement set.

10. The wireless communications method as in claim 1, wherein an estimate of an average rate is computed using the processed short-term CSI.

11. The wireless communications method as in claim 1, wherein the short-term CSI comprises:
a wideband precoding matrix indicator (PMI); and
a subband channel quality indicator (CQI).

12. The wireless communications method as in claim 1, wherein the short-term CSI comprises:
a wideband precoding matrix indicator (PMI);
a sub-band PMI; and
a subband channel quality indicator (CQI).

13. The wireless communications method as in claim 12, wherein the wideband PMI indicates an identity matrix.

14. The wireless communications method as in claim 1, wherein the short-term CSI is transmitted from a user equipment (UE) to said another TP.

15. A transmission point (TP) used in a mobile communications system, the transmission point (TP) comprising:
a receiver to receive, from another TP, short-term channel state information (short-term CSI),
wherein the TP processes the short-term CSI.

16. A wireless communications method implemented in mobile communications system, the wireless communications method comprising:
transmitting, to a transmission point (TP) from another TP, short-term channel state information (short-term CSI); and
processing the short-term CSI.
